(19) United States
(12) Patent Application Publication
(10) Pub. No.: US 2026/0025061 A1
(43) Pub. Date: Jan. 22, 2026

(54) PEAK VOLTAGE CONTROL TO MINIMIZE VOLTAGE ERROR OF PULSE FREQUENCY MODULATION MODE OF POWER CONVERTER

(71) Applicant: Cirrus Logic International Semiconductor Ltd., Edinburgh (GB)

(72) Inventors: Jason W. LAWRENCE, Austin, TX (US); Graeme G. MACKAY, Austin, TX (US); Michael J. MURPHY, Statesville, NC (US); Sameer ARORA, Austin, TX (US)

(73) Assignee: Cirrus Logic International Semiconductor Ltd., Edinburgh (GB)

(21) Appl. No.: 19/211,872

(22) Filed: May 19, 2025

Related U.S. Application Data
(60) Provisional application No. 63/673,230, filed on Jul. 19, 2024.

(51) Int. Cl. H02M 1/088; H02M 3/158

(52) U.S. Cl. CPC H02M 1/088; H02M 3/158

(57) ABSTRACT

A system may include a power converter comprising a power inductor and a plurality of switches and a controller configured to control the power converter, including controlling the power converter in discontinuous conduction mode to magnetize and demagnetize the power inductor, wherein the controller is further configured to, in each switching cycle of the power converter, terminate a magnetization period of the power inductor based on a function dependent upon an output voltage of the power converter and a power inductor current flowing through the power inductor.

### RELATED APPLICATION

The present disclosure claims priority to U.S. Provisional Patent Application No. 63/673,230, filed Jul. 19, 2024, which is incorporated by reference herein in its entirety.

### FIELD OF DISCLOSURE

The present disclosure relates in general to circuits for electronic devices, including without limitation personal audio devices such as wireless telephones and media players, and more specifically, peak voltage control, in addition to pulse frequency modulation control, or a power converter in order to minimize a voltage error that may occur in a pulse frequency modulation mode of a power converter.

### BACKGROUND

Personal audio devices, including wireless telephones, such as mobile/cellular telephones, cordless telephones, mp3 players, and other consumer audio devices, are in widespread use. Such personal audio devices may include circuitry for driving a pair of headphones, one or more speakers, haptic actuators, camera stabilization motors, and/or other loads. Such circuitry often includes a driver including a power amplifier for driving an output signal to such loads. Oftentimes, a power converter may be used to provide a supply voltage to a power amplifier in order to amplify a signal driven to speakers, headphones, other transducers, or other loads. A switching power converter is a type of electronic circuit that converts a source of power from one direct current (DC) voltage level to another DC voltage level. Examples of such switching DC-DC converters include but are not limited to a boost converter, a buck converter, a buck-boost converter, an inverting buck-boost converter, and other types of switching DC-DC converters. Thus, using a power converter, a DC voltage such as that provided by a battery may be converted to another DC voltage used to power the power amplifier. A power converter may be used to provide supply voltage rails to one or more components in a device. A power converter may also be used in other applications besides driving audio transducers, such as driving haptic actuators or other electrical or electronic loads. Further, a power converter may also be used in charging a battery from a source of electrical energy (e.g., an AC-to-DC adapter).

Power converters may be implemented using a power inductor and a plurality of switches. Such inductive-based power converters may be configured to operate in a plurality of modes, including a continuous conduction mode (CCM) and a discontinuous conduction mode (DCM), wherein DCM may also be referred to as pulse-frequency modulation (PFM) mode. In CCM, the switches of a power converter may be sequenced such that electrical current is continuously conducted through the power inductor throughout each switching cycle. In DCM/PFM mode, the switches of a power converter may be sequenced such that during portions of each switching cycle, electrical current through the power inductor may be zero. Further in DCM/PFM mode, during some switching cycles, the current through the power inductor may be zero throughout such cycles, such that certain pulses of inductor current are skipped.

FIG. 1 illustrates an example system 100 comprising a buck converter 101 and a controller 104 for controlling buck converter 102, as is known in the art. As shown in FIG. 1, buck converter 101 may include a power inductor 102 coupled between a switching node and an output of buck converter 101. Buck converter 101 may also include a plurality of switches 106a and 106b, wherein switch 106a is coupled between an input having an input voltage V_{IN} and the switching node and switch 106b is coupled between the switching node and a ground voltage. In operation, switches 106a and 106b may be controlled by controller 104 to regulate output voltage V_{OUT} to a desired target voltage V_{TGT}, as described in greater detail below.

As also shown in FIG. 1, controller 104 may include control logic configured to generate switching signals SW1 and SW2 for controlling switches 106a and 106b. Such control logic may include PFM control logic such as that shown in FIG. 1. Such control logic may include a high impedance (HiZ) latch 108, switch (SW) latch 110, an output voltage comparator 112, a zero-crossing detection comparator 114, and a current comparator 116. In operation, output voltage comparator 112 may compare sensed output voltage V_{OUT} to target voltage V_{TGT}, zero-crossing detection comparator 114 may compare a sensed power inductor current I_{L} to zero to detect a zero crossing of power inductor current I_{L}, and current comparator 116 may compare power inductor current I_{L} to a peak current threshold I_{PK}.

HiZ latch 108 may receive the output of zero-crossing detection comparator 114 at its set(S) input and receive the output of output voltage comparator 112 at its reset (R) input. SW latch 110 may receive the output of zero-crossing detection comparator 114 at its set(S) input and receive the output of current comparator 116 at its reset (R) input. The output of SW latch 110 may be inverted by an inverter 118, and the output of SW latch 110 may drive switching signal SW1 while the output of inverter 118 may drive switching signal SW2, with the output of SW latch 110 and the output of inverter 118 gated, by AND gates 120 and 122, with the inverted output of HiZ latch 108 (which may itself be inverted by inverter 124).

System 100 may also include a load 130. Buck converter 101 may drive output voltage V_{OUT} and a load current I_{LOAD} to such load 130.

The PFM control logic of controller 104 may control buck converter 101 among a number of switching configurations: (a) a charging configuration in which switch 106a is activated (e.g., on, closed, enabled) and switch 106b is deactivated (e.g., off, open, disabled), thus charging or magnetizing power inductor 102; (b) a discharging configuration in which switch 106a is deactivated and switch 106b is activated, thus discharging or demagnetizing power inductor 102; and (c) a HiZ configuration in which both switches 106a and 106b are deactivated.

FIG. 2A illustrates example waveforms for output voltage VOLT, power inductor current I_{L}, and load current I_{LOAD} when buck converter 101 is under the control of the PFM control logic of controller 104 in a peak current control mode of buck converter 101, as is known in the art. Further, although logic for such a mode is not shown in FIG. 1, FIG. 2B illustrates example waveforms for output voltage V_{OUT} and power inductor current I_{L} when buck converter 101 is in a passthrough mode of buck converter 101, as is known in the art. Such passthrough mode may occur when a difference between input voltage V_{IN} and output voltage V_{OUT} is very small, in which controller 104 may cause switch 106a to stay activated and switch 106b to stay activated. In such case, resistive losses in the circuit may cause a voltage across power inductor 102 to be approximately zero, and power inductor 102 and buck converter 101 may be in a steady state. With buck converter 101 in such steady state, it may act as a passthrough circuit in which output voltage V_{OUT} is maintained approximately equal to input voltage V_{IN}.

Control of a power converter as described above may have disadvantages. To illustrate, as input voltage V_{IN} slowly increases, output voltage V_{OUT} may steeply increase to where differences between input voltage V_{IN} and output voltage V_{OUT} are relatively small and buck converter 101 is in passthrough mode. However, buck converter 101 may remain in the passthrough mode (i.e., may get “stuck” and stay in passthrough mode too long) because the difference between input voltage V_{IN} and output voltage V_{OUT} may be small and thus buck converter 101 does not switch to regulate a peak for output voltage VOLT. For example, buck converter 101 may attempt to regulate output voltage V_{OUT} to 5V, but output voltage V_{OUT} may remain at a higher voltage (e.g., 10V) because buck converter 101 is “stuck” in the passthrough mode. Thus, output voltage V_{OUT} may have a large error from target voltage V_{TGT}. The severity of the error in passthrough mode may also depend on an initial condition of output voltage V_{OUT}. For example, buck converter 101 may attempt to regulate the output voltage to 5V, but if the voltage of the output capacitor (e.g., in parallel with load 130 in FIG. 1) is initialized at 10V and input voltage V_{IN} is 10V, output voltage V_{OUT} may remain at 10V because buck converter 101 may be “stuck” in passthrough mode. Thus, when buck converter 101 leaves passthrough mode and finally starts switching responsive to inductor current I_{L} reaching peak current threshold I_{PK}, the values of the peak of output voltage V_{OUT} and the average of output voltage V_{OUT} may be large and may remain “stuck” at such large values.

Generally, it may be desirable that actual average output voltage V_{OUT} not be more than one percent (1%) from target voltage V_{TGT}. However, at lower levels of input voltage V_{IN}, output voltage V_{OUT} may be unacceptably large. Therefore, because existing approaches provide only a way of controlling current without a feedback mechanism of monitoring and regulating over voltages of output voltage V_{OUT} when the differences between input voltage V_{IN} and output voltage V_{OUT} are small, such feedback control may be desired.

### SUMMARY

In accordance with the teachings of the present disclosure, one or more disadvantages and problems associated with existing control of power converters may be reduced or eliminated.

In accordance with embodiments of the present disclosure, a system may include a power converter comprising a power inductor and a plurality of switches and a controller configured to control the power converter, including controlling the power converter in discontinuous conduction mode to magnetize and demagnetize the power inductor, wherein the controller is further configured to, in each switching cycle of the power converter, terminate a magnetization period of the power inductor based on a function dependent upon an output voltage of the power converter and a power inductor current flowing through the power inductor.

In accordance with these and other embodiments of the present disclosure, a method may include, in a system having a power converter comprising a power inductor and a plurality of switches, controlling the power converter, including controlling the power converter in discontinuous conduction mode to magnetize and demagnetize the power inductor, and in each switching cycle of the power converter, terminating a magnetization period of the power inductor based on a function dependent upon an output voltage of the power converter and a power inductor current flowing through the power inductor.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system comprising a buck converter and a controller for controlling the buck converter, as is known in the art;

FIG. 2A illustrates example waveforms for an output voltage, a power inductor current, and a load current for the buck converter of FIG. 1 when such buck converter is under the control of PFM control logic of the controller of FIG. 1 in a peak current control mode of such buck converter, as is known in the art;

FIG. 2B illustrates example waveforms for an output voltage and a power inductor current for the buck converter of FIG. 1 when such buck converter is in a passthrough mode of such buck converter, as is known in the art;

FIG. 3 illustrates an example system comprising a buck converter and a controller for controlling the buck converter, in accordance with embodiments of the present disclosure;

FIG. 4A illustrates example waveforms for an output voltage and a power inductor current for the buck converter of FIG. 3 when such buck converter is in a passthrough mode of such buck converter, in accordance with embodiments of the present disclosure;

FIG. 4B illustrates example waveforms for an output voltage, a power inductor current, and a load current for the buck converter of FIG. 3 when such buck converter is under the control of PFM control logic of the controller of FIG. 3 in a peak voltage control mode of such buck converter, in accordance with embodiments of the present disclosure;

FIG. 4C illustrates example waveforms for an output voltage, a power inductor current, and a load current for the buck converter of FIG. 3 when such buck converter is under the control of PFM control logic of the controller of FIG. 3 in a peak current control mode of such buck converter, in accordance with embodiments of the present disclosure; and

FIG. 5 illustrates an example plot depicting a control mode of operation in relationship to a load current driven by a buck converter plotted against a difference between an input voltage and an output voltage of the buck converter, in accordance with embodiments of the present disclosure.

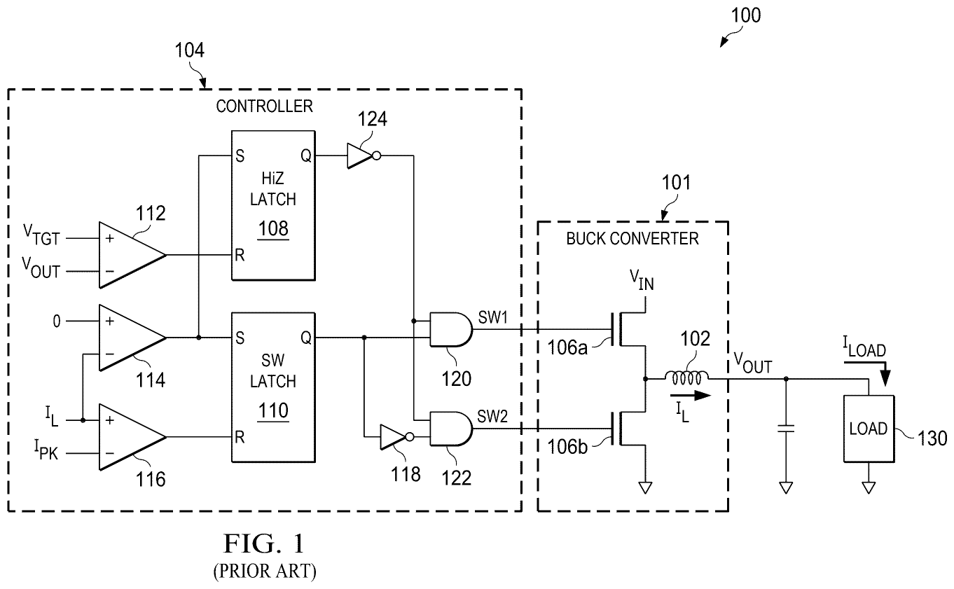

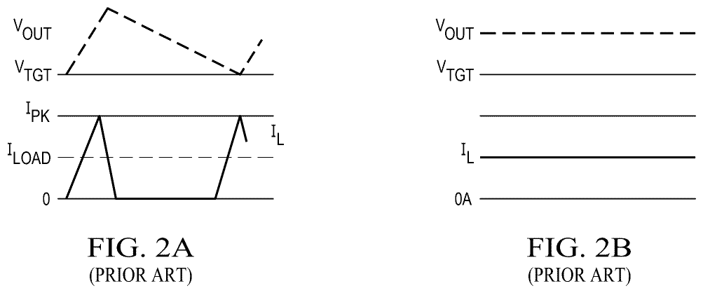

### DETAILED DESCRIPTION

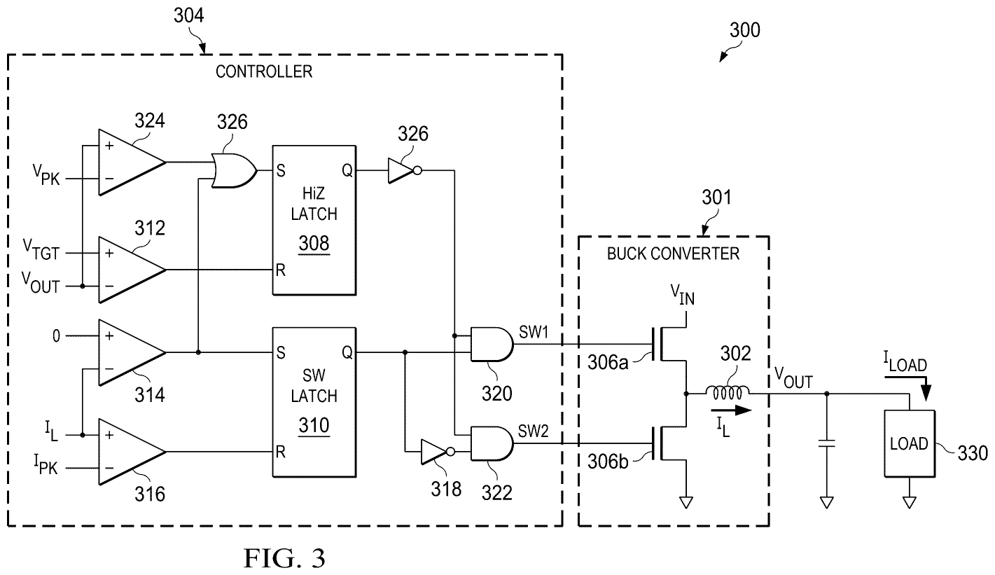

FIG. 3 illustrates an example system 300 comprising a buck converter 301 and a controller 304 for controlling the buck converter, in accordance with embodiments of the present disclosure. As shown in FIG. 3, buck converter 301 may include a power inductor 302 coupled between a switching node and an output of buck converter 301. Buck converter 301 may also include a plurality of switches 306a and 306b, wherein switch 306a is coupled between an input having an input voltage V_{IN} and the switching node and switch 306b is coupled between the switching node and a ground voltage. In operation, switches 306a and 306b may be controlled by controller 304 to regulate output voltage V_{OUT} to a desired target voltage V_{TGT}, as described in greater detail below.

As also shown in FIG. 3, controller 304 may include control logic configured to generate switching signals SW1 and SW2 for controlling switches 306a and 306b. Such control logic may include PFM control logic such as that shown in FIG. 3. Such control logic may include a high impedance (HiZ) latch 308, switch (SW) latch 310, an output voltage comparator 312, a zero-crossing detection comparator 314, a current comparator 316, and a peak voltage comparator 324. In operation, output voltage comparator 312 may compare sensed output voltage V_{OUT} to target voltage V_{TGT}, zero-crossing detection comparator 314 may compare a sensed power inductor current I_{L} to zero to detect a zero crossing of power inductor current I_{L}, current comparator 316 may compare power inductor current I_{L} to a peak current threshold I_{PK}, and peak voltage comparator 324 may compare sensed output voltage V_{OUT} to a peak voltage threshold VPK.

HiZ latch 308 may receive at its set(S) input a signal equivalent to a logical OR (e.g., using OR gate 326) of the output of zero-crossing detection comparator 314 and the output of peak voltage comparator 324. HiZ latch 308 may also receive the output of output voltage comparator 312 at its reset (R) input. SW latch 310 may receive the output of zero-crossing detection comparator 314 at its set(S) input and receive the output of current comparator 316 at its reset (R) input. The output of SW latch 310 may be inverted by an inverter 318, and the output of SW latch 310 may drive switching signal SW1 while the output of inverter 318 may drive switching signal SW2, with the output of SW latch 310 and the output of inverter 318 gated, by AND gates 320 and 322, with the inverted output of HiZ latch 308 (which may itself be inverted by inverter 326).

System 300 may also include a load 330. Buck converter 301 may drive output voltage V_{OUT} and a load current I_{LOAD} to such load 330.

The PFM control logic of controller 304 may control buck converter 301 among a number of switching configurations: (a) a charging configuration in which switch 306a is activated (e.g., on, closed, enabled) and switch 306b is deactivated (e.g, off, open, disabled), thus charging or magnetizing power inductor 302; (b) a discharging configuration in which switch 306a is deactivated and switch 306b is activated, thus discharging or demagnetizing power inductor 302; and (c) a HiZ configuration in which both switches 306a and 306b are deactivated.

In many respects, operation of system 300 may be similar to that of system 100 described in the Background section. However, with the addition of peak voltage comparator 324 and OR gate 326, system 300 may also operate in a peak voltage mode, in addition to the passthrough mode and peak current control mode in which system 100 may operate.

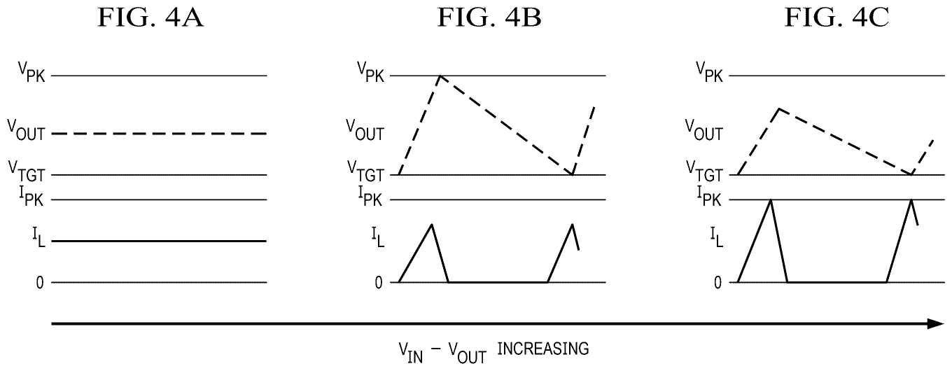

FIG. 4A illustrates example waveforms for output voltage V_{OUT} and power inductor current I_{L} for buck converter 301 when buck converter 301 is in a passthrough mode, in accordance with embodiments of the present disclosure. Logic within controller 304 is not explicitly shown in FIG. 3, but those of skill in the art would readily be capable of modifying the logic shown in FIG. 3 to achieve such mode. Such passthrough mode may occur when a difference between input voltage V_{IN} and output voltage V_{OUT} is very small, in which controller 304 may cause switch 306a to stay activated and switch 306b to stay activated. In such case, a difference between resistive losses is approximately zero, and power inductor 302 and buck converter 301 may be in a steady state. With buck converter 301 in such steady state, it may act as a passthrough circuit in which output voltage V_{OUT} is maintained approximately equal to input voltage V_{IN}.

FIG. 4B illustrates example waveforms for output voltage V_{OUT}, power inductor current I_{L}, and a load current I_{LOAD} for buck converter 301 when buck converter 301 is under the control of the PFM control logic of controller 304 in a peak voltage control mode, in accordance with embodiments of the present disclosure. The peak voltage control mode may be enabled by the presence of peak voltage comparator 324 and OR gate 326 feeding the set(S) input of HiZ latch 308. In essence, in such peak voltage control mode, peak voltage comparator 324 may sense when output voltage V_{OUT} exceeds peak voltage threshold VPK, and then cause (e.g., via HiZ latch 308 and logic downstream of HiZ latch 308) switches 306a and 306b to deactivate until such time as output voltage V_{OUT} falls below target voltage V_{TGT} (e.g., as detected by output voltage comparator 312) and a new switching cycle of buck converter 301 begins. With switches 306a and 306b deactivated, power inductor current I_{L} may flow through a body diode of switch 306b, thus grounding the switching node of buck converter 301. Such condition may cause power inductor current I_{L} to decrease and may cause output voltage V_{OUT} to stop increasing. Accordingly, the presence of the peak voltage control mode may eliminate or minimize the occurrence of peak voltage conditions of output voltage V_{OUT} which are described in the Background section of this disclosure and which may otherwise manifest as large ripples of output voltage V_{OUT} in the absence of the peak voltage control mode.

FIG. 4C illustrates example waveforms for output voltage VOLT, power inductor current I_{L}, and a load current I_{LOAD} for buck converter 301 when buck converter 301 is under the control of the PFM control logic of controller 304 in a peak current control mode, in accordance with embodiments of the present disclosure. As shown in FIG. 4C, when operating in the peak current control mode, controller 304 may perform peak current control of buck converter 301 such that in each switching cycle: (a) responsive to output voltage V_{OUT} falling below target voltage V_{TGT} (e.g., as detected by output voltage comparator 312), controller 304 may cause charging/magnetizing of power inductor 102; (b) responsive to power inductor current I_{L} meeting or exceeding peak inductor current I_{PK} (e.g., as detected by current comparator 316), controller 304 may cause discharging/demagnetizing of power inductor 102; and (c) responsive to a zero-crossing event of power inductor current I_{L} (e.g., as detected by zero-crossing comparator 314), controller 304 may cause buck converter 101 to enter a HiZ configuration in which both switches 306a and 306b are deactivated.

Notably as shown in FIGS. 4A-4C, the passthrough mode may occur when the difference between input voltage V_{IN} and output voltage V_{OUT} is low, and then as such difference increases, buck converter 301 may transition to the peak voltage control mode rather than the peak current control mode.

The various comparison thresholds described herein (e.g., target voltage V_{TGT}, peak voltage threshold VPK, and peak current threshold I_{PK}) may be fixed or may be variable based on system conditions. For example, in some embodiments, peak voltage threshold VPK may be dynamically adjusted based on measured (or estimated) operational states (e.g., input voltage V_{IN}, output voltage VOLT, load current I_{LOAD}) in order to control or optimize ripple of output voltage VOLT, the switching frequency of buck converter 301, and/or other characteristics of system 300. As another example, in these and other embodiments, peak current threshold I_{PK} may be dynamically adjusted based on measured (or estimated) operational states in order to control or optimize ripple of output voltage V_{OUT}, the switching frequency of buck converter 301, and/or other characteristics of system 300. In addition to switching among the various modes based on the thresholds described above, such switching among modes may occur based on comparisons with other thresholds. For example, in some embodiments, controller 304 may be configured such that, in each switching cycle, based on a comparison of output voltage V_{OUT} to a second fixed threshold voltage (e.g., other than peak voltage threshold VPK), controller 304 activates a discharge switch (not explicitly shown in the figures) coupled between a ground voltage and the output of buck converter 301 (i.e., the electrical node at which output voltage V_{OUT} is generated) to rapidly discharge output voltage VOLT. In such embodiments, system 300 may further include a shunt resistor coupled between the discharge switch and the ground voltage. Further in these embodiments, controller 304 may be configured to perform the comparison of output voltage to the second fixed threshold voltage during the magnetizing period of buck converter 301. In addition, in such embodiments, controller 304 may be configured to disable the comparison of output voltage V_{OUT} to the second fixed threshold voltage and disable comparison of power inductor current I_{L} and peak current threshold I_{PK} for a fixed period of time at the beginning of the magnetizing period of buck converter 301.

In these and other embodiments, controller 304 may be further configured to, in each switching cycle, terminate the magnetization period of power inductor 302 when power inductor current I_{L} is greater than peak current threshold I_{PK} or when power inductor current I_{L} is greater than a sum of peak current threshold I_{PK} and an amount proportional to an error between output voltage V_{OUT} and peak voltage threshold VPK.

As a further example, in some embodiments, controller 304 may use the output of peak voltage comparator 324 to set SW latch 310 in lieu of using the output of peak voltage comparator 324 to reset setting HiZ latch 308, as shown above. In such embodiments, the efficiency of power converter 301 may be maximized.

In these and other embodiments, controller 304 may be configured to use a second peak voltage threshold (e.g., that may also use peak voltage comparator 324 or another comparator with the value of the second peak voltage threshold value possibly being set to a little higher value than peak voltage threshold VPK) in order to enable a discharge switch coupled between the output of buck converter 301 (the electrical node at which output voltage V_{OUT} is generated) and ground voltage in order to rapidly discharge output voltage V_{OUT}. In such embodiments, such fast discharge can be accomplished by coupling the output of buck converter 301 to a resistor and/or to ground voltage. Furthermore, in such embodiments, system 300 may include an additional shunt resistor coupled between the discharge switch and ground voltage. These embodiments may help maximize the bandwidth of control of output voltage V_{OUT} when the error between output voltage V_{OUT} and target voltage V_{TGT} is large.

In these and other embodiments, peak voltage comparator 324 may be configured to be enabled or disabled based on states of switches 306a and 306b. Such enabling and disabling may prevent small pulses (glitches) from appearing at the control inputs for switching control signal SW2. In such embodiments, peak voltage comparator 324 may only be enabled depending on states of switches 306a and 306b. To illustrate motivation for such enabling/disabling, buck converter 301 may enter its discharge period and in a short time, peak voltage comparator 324 may trip and go into the HiZ mode. In this situation, switch 306b may remain on for an infinitesimally small amount of time which may result in a glitch. However, the selective enabling and disabling discussed in this paragraph may minimize or eliminate such glitch. In other words, output voltage V_{OUT} may only be used for comparison by peak voltage comparator 324 when switch 306a is active and output voltage V_{OUT} may be blanked or ignored by peak voltage comparator 324 when switch 306b is active.

In these and other embodiments, a small delay may be added between an enable signal for enabling peak voltage comparator 324 based on states of switches 306a and 306b and actual enablement of peak voltage comparator 324. Such delay may prevent small pulses/glitches from appearing at the gate of switch 306a, thus preventing switch 306a from being active for an infinitesimally small amount of time. In variations of these embodiments, peak voltage comparator 324 may only be enabled in the magnetization period of buck converter 301 and delay is added to ensure that buck converter 301 remains in the magnetization period for at least the amount of delay, such that switch 306a cannot be deactivated for at least such amount of delay.

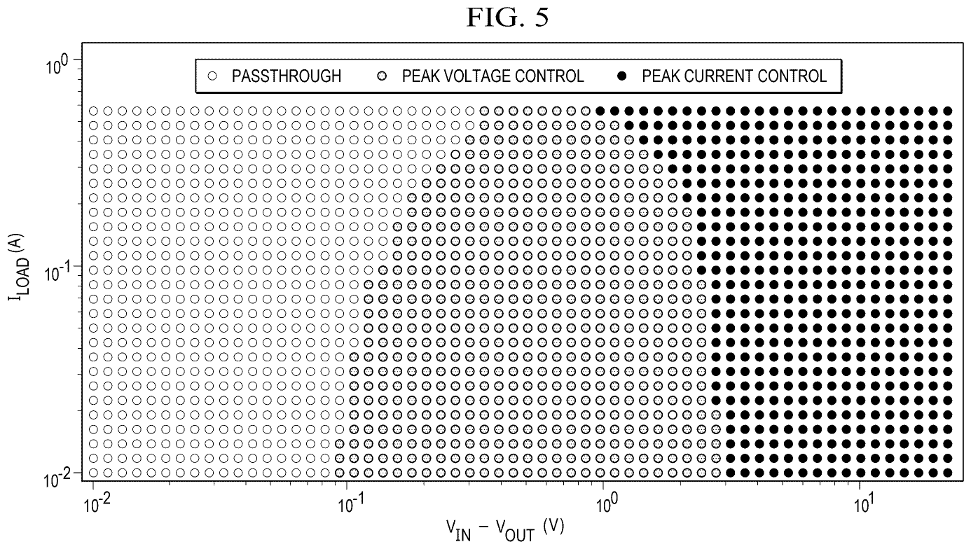

FIG. 5 illustrates an example plot depicting a control mode of operation for buck converter 301 in relationship to load current I_{LOAD} driven by buck converter 301 plotted against a difference between input voltage V_{IN} and output voltage V_{OUT} of buck converter 301, in accordance with embodiments of the present disclosure. In other words, FIG. 5 depicts the operational mode (e.g., passthrough mode, peak voltage control mode, peak current control mode) of buck converter 301 plotted over the state space of buck converter 301. As shown in FIG. 5, peak voltage control mode may be used throughout the state space, and not only in no-load scenarios. These three modes of operation may be available throughout the state space (wherein “state space” refers to a geometric space where the axes are the state variables of a system, and the system's state at any given time is represented as a point within that space), and controller 304 may seamlessly transition among the three modes.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

What is claimed is:

1. A system comprising:
a power converter comprising a power inductor and a plurality of switches; and
a controller configured to control the power converter, including controlling the power converter in discontinuous conduction mode to magnetize and demagnetize the power inductor, wherein the controller is further configured to, in each switching cycle of the power converter, terminate a magnetization period of the power inductor based on a function dependent upon an output voltage of the power converter and a power inductor current flowing through the power inductor.

2. The system of claim 1, wherein the controller is further configured to, in each switching cycle, initiate the magnetization period by comparison of the output voltage to a reference voltage.

3. The system of claim 2, wherein the controller is further configured to, in each switching cycle, terminate the magnetization period when the power inductor current is greater than a threshold current or when the output voltage is greater than a threshold voltage.

4. The system of claim 3, wherein the controller is further configured to, in each switching cycle, based on a comparison of the output voltage to a second threshold voltage, activate a discharge switch coupled between a ground voltage and an output of the power converter at which the output voltage is generated to rapidly discharge the output voltage.

5. The system of claim 4, comprising a shunt resistor coupled between the discharge switch and the ground voltage.

6. The system of claim 4, wherein the controller is configured to perform the comparison of the output voltage to the second threshold voltage during the magnetization period.

7. The system of claim 4, wherein the controller is configured to disable the comparison of the output voltage to the second threshold voltage and disable comparison of the power inductor current and the current threshold for a period of time at the beginning of the magnetization period.

8. The system of claim 2, wherein the controller is further configured to, in each switching cycle, terminate the magnetization period when the power inductor current is greater than a current threshold or when the power inductor current is greater than a sum of the current threshold and an amount proportional to an error between the output voltage and a threshold voltage.

9. The system of claim 2, wherein the voltage threshold is fixed.

10. The system of claim 2, wherein the voltage threshold is variable.

11. The system of claim 2, wherein the controller is configured to selectively enable and disable the comparison based on states of one or more of the plurality of switches.

12. The system of claim 1, wherein the power converter is a buck converter.

13. The system of claim 1, wherein the controller is configured to operate the power converter in a plurality of modes including:
a passthrough mode in which a first switch of the plurality of switches remains closed in order to pass a current of the power converter to an output of the power converter;
a peak voltage control mode in which the controller controls the switches to transition, in response to an output voltage at the output of the power converter exceeding a peak voltage threshold, from a charging configuration of the plurality of switches that charges the power inductor to a high-impedance configuration of the plurality in which a power inductor current of the power inductor flows through a body diode of a second switch of the plurality of switches to a ground voltage in order to decrease the power inductor current and prevent an increase to the output voltage; and
a peak current control mode in which the controller controls the switches to transition in response to the power inductor current exceeding a peak current threshold, from a charging configuration of the plurality of switches that charges the power inductor to a discharging configuration of the plurality of switches that discharges the power inductor.

14. A method comprising, in a system having a power converter comprising a power inductor and a plurality of switches:
controlling the power converter, including controlling the power converter in discontinuous conduction mode to magnetize and demagnetize the power inductor; and
in each switching cycle of the power converter, terminating a magnetization period of the power inductor based on a function dependent upon an output voltage of the power converter and a power inductor current flowing through the power inductor.

15. The method of claim 14, further comprising, in each switching cycle, initiating the magnetization period by comparison of the output voltage to a reference voltage.

16. The method of claim 15, further comprising, in each switching cycle, terminating the magnetization period when the power inductor current is greater than a threshold current or when the output voltage is greater than a threshold voltage.

17. The method of claim 16, further comprising, in each switching cycle, based on a comparison of the output voltage to a second threshold voltage, activating a discharge switch coupled between a ground voltage and an output of the power converter at which the output voltage is generated to rapidly discharge the output voltage.

18. The method of claim 17, wherein a shunt resistor is coupled between the discharge switch and the ground voltage.

19. The method of claim 17, further comprising performing the comparison of the output voltage to the second threshold voltage during the magnetization period.

20. The method of claim 17, further comprising disabling the comparison of the output voltage to the second threshold voltage and disabling comparison of the power inductor current and the current threshold for a period of time at the beginning of the magnetization period.

21. The method of claim 15, further comprising, in each switching cycle, terminating the magnetization period when the power inductor current is greater than a current threshold or when the power inductor current is greater than a sum of the current threshold and an amount proportional to an error between the output voltage and a threshold voltage.

22. The method of claim 15, wherein the voltage threshold is fixed.

23. The method of claim 15, wherein the voltage threshold is variable.

24. The method of claim 15, further comprising selectively enabling and disabling the comparison based on states of one or more of the plurality of switches.

25. The method of claim 14, wherein the power converter is a buck converter.

26. The method of claim 14, further comprising operating the power converter in a plurality of modes including:
a passthrough mode in which a first switch of the plurality of switches remains closed in order to pass a current of the power converter to an output of the power converter;
a peak voltage control mode in which the switches are controlled to transition, in response to an output voltage at the output of the power converter exceeding a peak voltage threshold, from a charging configuration of the plurality of switches that charges the power inductor to a high-impedance configuration of the plurality in which a power inductor current of the power inductor flows through a body diode of a second switch of the plurality of switches to a ground voltage in order to decrease the power inductor current and prevent an increase to the output voltage; and
a peak current control mode in which the switches are controlled to transition in response to the power inductor current exceeding a peak current threshold, from a charging configuration of the plurality of switches that charges the power inductor to a discharging configuration of the plurality of switches that discharges the power inductor.
